(19) United States
(12) Patent Application Publication
(10) Pub. No.: US 2005/0282081 A1
(43) Pub. Date: Dec. 22, 2005

(54) Printing plate material and image formation process

(75) Inventor: Takahiro Mori, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/153,390

(22) Filed: Jun. 16, 2005

(30) Foreign Application Priority Data
Jun. 21, 2004 (JP) JP2004-182304

(51) Int. Cl. G03C 1/492

(52) U.S. Cl. 430/270.1

(57) ABSTRACT

Disclosed is a printing plate material comprising a hydrophilic support having a hydrophilic surface, and provided thereon, an image formation layer, wherein the hydrophilic surface of the hydrophilic support has a reflection density of not less than 1.0, and a reflection density of the image formation layer side surface of the printing plate material is not less than 0.2 lower than that of the hydrophilic surface.

This application is based on Japanese Patent Application No. 2004-182304 filed on Jul. 21, 2004 in Japanese Patent Office, the entire content of which is hereby incorporated by reference.

### FIELD OF THE INVENTION

The present invention relates to a printing plate material and an image formation process employing the printing plate material, and particularly to a printing plate material capable of forming an image according to a computer to plate (CTP) system, and an image formation process employing the printing plate material.

### BACKGROUND OF THE INVENTION

Presently, printing employing a CTP system has been conducted in printing industries, accompanied with the digitization of printing data. A printing plate material for CTP, which is inexpensive, can be easily handled, and has printability comparable with that of a PS plate, is required.

Particularly in recent years, a printing plate material has been sought which does not require any development employing a developer containing specific chemicals (such as alkalis, acids, and solvents), and can be applied to a conventional printing press. Known are a chemical-free type printing plate material such as a phase change type printing plate material requiring no development process, a printing plate material which can be processed with water or a neutral processing liquid comprised mainly of water, or a printing plate material capable of being developed on a printing press at initial printing stage and requiring no development process; and a printing plate material called a processless printing plate material.

In the CTP system, a process so-called “plate inspection” is required in present work flow as in a conventional PS plate. In the case where a printing plate material is developed and punched to form holes for mounting on a plate cylinder of a printing press, register marks are read through employing a dedicated device and their correct positions are determined. Therefore, it is necessary to have a reflection density difference between image portions and non-image portions of the developed printing plate material whereby the register marks can be read, and a printing plate material is required to provide so-called a development visualization property.

A printing plate material requiring no development process or a processless printing plate material to be developed on a plate cylinder of a printing press is required to provide an exposure visualization property, since it is punched after imagewise exposure to form holes for mounting on the plate cylinder.

As the printing plate material described above which can be processed with water or a neutral processing liquid comprised mainly of water, there is a heat melt type printing plate material comprising an aluminum support and provided thereon, a heat melt image formation layer containing thermoplastic particles, a water-soluble binder, a light-to-heat conversion material, and a colorant, which can be removed employing with water or a neutral solution containing water mainly (see Japanese Patent O.P.I. Publication No. 2000-225780). This printing plate material is a negative-working printing plate material which is imagewise exposed and developed, where the thermoplastic particles of the image formation layer are heated and heat melted at exposed portions to form hydrophobic image portions which cannot be removed with a processing liquid such as water. In this printing plate material, a colorant having a high contrast to a (gray) aluminum support is employed as the colorant. For example, a black colorant such as carbon black is employed, which serves also as a light-to-heat conversion material.

It is inevitable in the image formation layer described above that image portions after development have poor water resistance at some parts, since the image formation layer is formed in a state capable of being removed with a processing liquid such as water. When printing is carried out employing dampening water, image portions with poor water resistance, to which stronger force is applied, may be removed during printing, and as a result, colorants contained in the image formation layer are incorporated into printing ink or dampening water, which results in contamination due to a printing press (so-called color contamination), which lowers color reproduction of color images.

A processless printing plate material is imagewise exposed employing an infrared laser with an emission wavelength of from near-infrared to infrared regions to form an image. The thermal processless printing plate material employing this method is divided into three types: an ablation type printing plate material, a development-on-press type printing plate material with a heat melting image formation layer; and a phase change type printing plate material, each described later.

Examples of the ablation type printing plate material include those disclosed in for example, Japanese Patent O.P.I. Publication Nos. 8-507727, 6-186750, 6-199064, 7-314934, 10-58636 and 10-244773.

These references disclose a printing plate material comprising a support, and provided thereon, a hydrophilic layer and a lipophilic layer, either of which is an outer layer. When a printing plate material is imagewise exposed in which the hydrophilic layer is an outer layer, the hydrophilic layer is removed by ablation to reveal the lipophilic layer, whereby an image is formed. This printing plate material has problem that the exposure device is contaminated by the ablated material. In order to solve this problem, a printing plate material is proposed in which a water-soluble protective layer is provided on the hydrophilic layer so as to prevent the ablated material from scattering matter. This printing plate material is mounted on a plate cylinder of a printing press, and the ablated material is removed together with the protective layer on the plate cylinder.

It is possible to give an exposure visualization property to such a printing plate material employing an outer layer and a lower layer under the outer layer different in hues from each other. However, in order to realize the visualization, it is necessary to completely ablate and remove the outer layer. This can be realized by suctioning the ablated layer, for example, through a cleaner installed in an exposure device, but the cleaner install results in cost increase.

It is difficult to obtain good exposure visualization in the printing plate material described above having the protective layer in which hues of the outer layer and the lower layer are different, since there is problem that a layer to be ablated is not completely removed.

In order to solve the above problem, there has been proposed a printing plate material comprising a hydrophilic overcoat layer, which is capable of being removed on a printing press, containing not less than 20% by weight of a cyanine infrared absorbing dye whose optical density varies due to exposure (see Japanese Patent O.P.I. Publication No. 11-140270).

This printing plate material gives good exposure image visualization, but it is difficult to avoid color contamination caused due to development on press, since the high dye content of the overcoat layer to be removed on a printing press exhibits a high color density in either exposed potions or unexposed portions, whether a color density of the layer increases or decreases due to exposure.

As the development-on-press type printing plate material, there is a printing plate material disclosed in JP-2938397 which comprises a hydrophilic layer or a grained aluminum plate and provided thereon, an image forming layer containing thermoplastic particles and a water soluble binder.

In order to provide an exposure visualization property to this type printing plate material, an infrared absorbing dye, which discolors on exposure, is employed. In the printing plate material comprising an image formation layer containing such an infrared absorbing dye, increase of the difference in color density between exposed portions and unexposed portions is to increase a color density of the image formation layer at unexposed portions, resulting in color contamination due to an image formation layer at the unexposed portions during development on-press (see Japanese Patent O.P.I. Publication No. 2002-205466).

As the phase change type printing plate material, there is a printing plate material comprising a hydrophilic layer containing hydrophobic precursor particles which changes to be hydrophobic at exposed portions, the hydrophilic layer being not removed during printing.

In order to provide an exposure visualization property to this type printing plate material, the infrared absorbing dye described above, which discolors on exposure, is employed. In the printing plate material comprising a hydrophilic layer containing such an infrared absorbing dye, the infrared absorbing dye is preferably hydrophilic or water-soluble. In this case, the infrared dye is dissolved out in dampening water during printing, resulting in color contamination due to a printing press as described above.

Use of a dye, which is insoluble in water and is not dissolved in dampening water, lowers hydrophilicity of the hydrophilic layer, resulting in problem of stain occurrence.

As a printing plate material capable of being developed during printing, there is known a printing plate material comprising an image formation layer containing materials colored due to heating such as a leuco dye and a color developing agent, wherein only exposed portions or hydrophobic image portions color (see Japanese Patent O.P.I. Publication No. 2000-225780). This type printing plate material, in which the image formation layer at non-image portions to be removed during printing, has a relatively low color density, and reduces degree of color contamination, compared with one employing a dye which discolors on exposure. However, there is problem in that image portions to have been colored partially have regions with a low water resistance, resulting in color contamination due to colored image portions. Further, there is problem in that reproduction of small dots is lowered in long run of printing.

As described above, a conventional technique in the chemical-free CTP system or the processless CTP system is difficult to reduce contamination of an exposure device or color contamination due to a printing press, to prevent stain occurrence, and to provide high printing durability and a sufficient visualization property.

### SUMMARY OF THE INVENTION

An object of the invention is to provide a printing plate material which reduces contamination of an exposure device or color contamination due to a printing press, prevents stain occurrence, and provides high printing durability and an excellent visualization property; and an image formation process employing the printing plate material.

### DETAILED DESCRIPTION OF THE INVENTION

The above object of the invention can be attained by the following constitutions.

1. A printing plate material comprising a hydrophilic support having a hydrophilic surface, and provided thereon, an image formation layer, wherein the hydrophilic surface of the hydrophilic support has a reflection density of not less than 1.0, and a reflection density of the image formation layer side surface of the printing plate material is not less than 0.2 lower than that of the hydrophilic surface.

2. The printing plate material of item 1 above, wherein the reflection density of the image formation layer side surface is not less than 0.3 lower than that of the hydrophilic surface.

3. The printing plate material of item 2 above, wherein the reflection density of the image formation layer side of the surface is not less than 0.4 lower than that of the hydrophilic surface.

4. The printing plate material of item 1 above, wherein the hydrophilic surface is a hydrophilic layer surface, the hydrophilic layer containing a colorant.

5. The printing plate material of item 4 above, wherein the colorant content of the hydrophilic layer is from 10 to 80% by weight.

6. The printing plate material of item 4 above, wherein the colorant is black pigment selected from titanium black, a complex metal oxide pigment, a black iron oxide pigment, and carbon black pigment covered with silica materials.

7. The printing plate material of item 1 above, wherein the image formation layer contains white pigment.

8. The printing plate material of item 7 above, wherein the white pigment content of the image formation layer is 5 to 90% by weight.

9. The printing plate material of item 7 above, wherein the white pigment is selected from titanium oxide, and hollow polymer particles.

10. The printing plate material of item 1 above, wherein the image formation layer contains white heat melting particles having a melting point of from 60 to 150° C.

11. The printing plate material of item 10 above, wherein the white heat melting particle content of the image formation layer is 40 to 100% by weight.

12. The printing plate material of item 10 above, wherein the white heat melting particles are selected from particles of paraffin wax, polyethylene wax, carnauba wax, and microcrystalline wax.

13. The printing plate material of item 1 above, wherein the image formation layer is capable of being developed with water.

14. The printing plate material of item 1 above, wherein the image formation layer is capable of being developed on a printing press.

15. An image formation process employing the printing plate material of item 1 above, the process comprising the steps of imagewise exposing the printing plate material; and developing the exposed printing plate material to remove an image formation layer at unexposed portions.

16. An image formation process employing the printing plate material of item 1 above, the process comprising the steps of imagewise exposing the printing plate material, so that a reflection density of the image formation layer side surface of the printing plate material is not less than 0.2 higher at exposed portions than at unexposed portions.

17. The image formation process of item 16 above, wherein the imagewise exposure is carried out at exposure energy of from 50 to 1000 mJ/cm².

18. The image formation process of item 16 above, wherein the image formation layer contains white heat melting particles having a melting point of from 60 to 150° C.

19. The image formation process of item 18 above, wherein the white heat melting particle content of the image formation layer is 40 to 100% by weight.

20. The image formation process of item 18 above, wherein the white heat melting particles are selected from particles of paraffin wax, polyethylene wax, carnauba wax, and microcrystalline wax.

1-1. A printing plate material comprising a support having a hydrophilic surface, and provided thereon, an image formation layer, wherein the hydrophilic surface of the hydrophilic support has a reflection density of not less than 1.0, and a reflection density of the image formation layer surface is not less than 0.2 lower than that of the hydrophilic surface.

1-2. The printing plate material of item 1-1 above, wherein the reflection density of the image formation layer surface is not less than 0.3 lower than that of the hydrophilic surface.

1-3. The printing plate material of item 1-2 above, wherein the reflection density of the image formation layer surface is not less than 0.4 lower than that of the hydrophilic surface.

1-4. The printing plate material of any one of items 1-1 through 1-3 above, wherein the image formation layer contains white pigment.

1-5. The printing plate material of any one of items 1-1 through 1-4 above, wherein the image formation layer is capable of being developed with water.

1-6. The printing plate material of any one of items 1-1 through 1-5 above, wherein the image formation layer is capable of being developed on a printing press.

1-7. An image formation process employing the printing plate material of any one of items 1-1 through 1-6 above, the process comprising the steps of imagewise exposing the printing plate material, and developing the exposed printing plate material to remove the image formation layer at unexposed portions.

1-8. An image formation process employing the printing plate material of item 1-1 above, the process comprising the steps of imagewise exposing the printing plate material, so that a reflection density of the image formation layer surface is not less than 0.2 higher at exposed portions than at unexposed portions.

1-9. The image formation process of item 1-8 above, wherein the image formation layer contains heat melting white pigment.

1-10. A printing plate material used in the image formation process of item 1-8 or 1-9 above.

The present invention is characterized in that in a printing plate material comprising a hydrophilic support having a hydrophilic surface, and provided thereon, an image formation layer, wherein the hydrophilic surface of the hydrophilic support has a reflection density of not less than 1.0, and the reflection density of the image formation layer side surface is not less than 0.2 lower than that of the hydrophilic surface (hereinafter also referred to as first embodiment).

The present invention is characterized in that in an image formation process employing the printing plate material above, the process comprises the steps of imagewise exposing the printing plate material, and developing the exposed printing plate material to remove the image formation layer at unexposed portions (hereinafter also referred to as second embodiment).

The present invention is characterized in that in an image formation process employing a printing plate material comprising a support having a hydrophilic surface, and provided thereon, an image formation layer, in which the hydrophilic surface of the hydrophilic support has a reflection density of not less than 1.0, and a reflection density of the surface on the image formation layer side is not less than 0.2 lower than that of the hydrophilic surface, the process comprises the steps of imagewise exposing the printing plate material, so that a reflection density of the surface on the image formation layer side is not less than 0.2 higher at exposed portions than at unexposed portions (hereinafter also referred to as third embodiment).

The reflection density in the invention is one determined based on absolute white, employing a reflection densitometer Macbeth D 196 produced by Gretag-Macbeth Co., Ltd.

When a hydrophilic support having a hydrophilic surface is transparent, a sample to be measured being provided on a white base (for example, a base in which four coated paper sheets used in printing are superposed one over the other), the reflection density is determined.

The hydrophilic surface in the invention refers to a surface of a layer capable of forming non-image portions during printing, and the reflection density of the hydrophilic surface is that of the surface of a layer capable of forming non-image portions as described above, which is obtained by measuring the hydrophilic surface of a printing plate material which has been disclosed after the image formation layer has been removed by development.

The reflection density of the surface on the image formation layer side is that of the surface on the image formation layer side of the printing plate material comprising the image formation layer provided on the support described above, which is obtained by measuring the surface on the image formation layer side.

### First and Second Embodiments

The first and second embodiments can be obtained by the following steps.
a. A step of preparing a hydrophilic support having a hydrophilic surface having a reflection density of not less than 1.0.
b. A step of providing, on the hydrophilic support, an image formation layer so that the surface on the image formation layer side has a reflection density not less than 0.2 lower than that of the hydrophilic surface to prepare a printing plate material.
c. A step of exposing the resulting printing plate material to fix an image formation layer at exposed portions onto the hydrophilic support.
d. A step of developing the exposed printing plate material to remove an image formation layer at unexposed portions.
   (Hydrophilic Support Having a Hydrophilic Surface)

The hydrophilic support in the invention having a hydrophilic surface has a hydrophilic surface with a reflection density of not less than 1.0, preferably from 1.0 to 3.0, and more preferably from 1.5 to 3.0, in view of a visualization property.

Examples of the hydrophilic support having a hydrophilic surface include the following (A) and (B), but are not limited thereto.
(A) A hydrophilic support in which an aluminum or aluminum alloy plate is surface-roughened and anodized to form an anodization layer, and the anodization layer is subjected to known coloration treatment to give a hydrophilic surface having a reflection density of not less than 1.0.
(B) A hydrophilic support in which a hydrophilic layer containing a colorant is provided on any substrate so as to have a hydrophilic surface having a reflection density of not less than 1.0.

In order to obtain the hydrophilic support (A) above, known methods for preparing a grained aluminum support are applied to the surface-roughening and anodization. The coloration treatment is preferably carried out employing an electrolytic coloration method, for example, a method disclosed in Japanese Patent O.P.I. Publication No. 2000-267291. It is preferred that the coloration-treated anodization layer is further subjected to a known hydrophilization treatment.

Hue of the colorant in hydrophilic support (B) is not specifically limited. The colorant is preferably a colorant having a light-to-heat conversion function in view of sensitivity. In order to increase light-to-heat conversion efficiency, a black pigment is preferred. As a colorant which does not lower hydrophilicity of the hydrophilic layer, the preferred colorant is a metal oxide or a colorant covered with a metal oxide.

Examples of the colorant which has a good light-to-heat conversion efficiency and does not lower hydrophilicity of the hydrophilic layer include titanium black, a complex metal oxide pigment such as a Cu—Cr—Mn complex disclosed in Japanese Patent O.P.I. Publication No. 2002-370465, a black iron oxide pigment, and carbon black pigment covered with silica materials disclosed in Japanese Patent O.P.I. Publication No. 2001-47755. Examples of a colorant having light-to-heat conversion efficiency include a light-to-heat conversion material described later.

The hydrophilic surface having a reflection density of not less than 1.0 is obtained by appropriately adjusting a particle size, a particle size distribution, or a content in the hydrophilic layer of colorants such as pigments above, or a dry coating amount of the hydrophilic layer.

For example, the colorant content of the hydrophilic layer is preferably from 10 to 80% by weight, and more preferably from 20 to 70% by weight, in view of sensitivity and printing durability. The dry coating amount of the hydrophilic layer is preferably from 0.5 to 20 g/m², and more preferably from 1 to 10 g/m², in view of reflection density and adhesion of the hydrophilic layer to the support.

In the invention, hydrophilic support (B), in which a hydrophilic layer containing a colorant is provided on a substrate, is preferred, since a hydrophilic surface having a reflection density of not less than 1.0, and preferably not less than 1.5 is relatively easily obtained.

Material used in the hydrophilic layer is preferably a water-insoluble hydrophilic material, and especially preferably a metal oxide.

The metal oxide is preferably metal oxide particles. Examples of the metal oxide particles include colloidal silica particles, an alumina sol, a titania sol and another metal oxide sol. The metal oxide particles may have any shape such as spherical, needle-like, and feather-like shape. The average particle size is preferably from 3 to 100 nm, and plural kinds of metal oxide each having a different size may be used in combination. The surface of the particles may be subjected to surface treatment.

Among the above-mentioned, colloidal silica is particularly preferred.

The hydrophilic layer in the invention preferably contains porous metal oxide particles as metal oxides. Examples of the porous metal oxide particles include porous silica particles, porous aluminosilicate particles or zeolite particles.

The particle size of the porous metal oxide particles dispersed in the hydrophilic layer is preferably not more than 1 μm, and more preferably not more than 0.5 μm.

The hydrophilic layer in the invention may contain a light-to-heat conversion material as described later, in addition to the colorant.

In the invention, the hydrophilic layer can contain a hydrophilic organic resin. Examples of the hydrophilic organic resin include polysaccharides, polyethylene oxide, polypropylene oxide, polyvinyl alcohol, polyethylene glycol (PEG), polyvinyl ether, a styrene-butadiene copolymer, a conjugation diene polymer latex of methyl methacrylate-butadiene copolymer, an acryl polymer latex, a vinyl polymer latex, polyacrylamide, polyvinyl pyrrolidone, and cellulose derivatives such as oligosaccharides, polysaccharides and starch.

A water-soluble surfactant may be added for improving the coating ability of the coating liquid for the hydrophilic layer in the invention. A silicon atom-containing surfactant and a fluorine atom-containing surfactant are preferably used. The silicon atom-containing surfactant is especially preferred in that it minimizes printing contamination.

(Substrate)

The substrate for the hydrophilic support in the invention is a plate or film capable of carrying an image formation layer, and as such a substrate, those well known in the art as substrates for printing plates can be used.

Examples of the substrate include a metal plate, a plastic film sheet, a paper sheet treated with polyolefin, and composite sheets such as laminates thereof. The thickness of the substrate is not specifically limited as long as a printing plate having the substrate can be mounted on a printing press, and is advantageously from 50 to 500 μm in easily handling.

Examples of the metal plate include iron, stainless steel, and aluminum. Aluminum is especially preferable in its gravity and stiffness. Aluminum is ordinarily used after degreased with an alkali, an acid or a solvent to remove oil on the surface, which has been used when rolled and wound around a spool.

Examples of the plastic film include a polyethylene terephthalate film, a polyethylene naphthalate film, a polyimide film, a polyamide film, a polycarbonate film, a polysulfone film, a polyphenylene oxide film, and a cellulose ester film. The plastic film is preferably a polyethylene terephthalate film or a polyethylene naphthalate film. In order to increase adhesion between the support and a coating layer, it is preferred that the surface of the plastic film is subjected to adhesion increasing treatment or is coated with a subbing layer. Examples of the adhesion increasing treatment include corona discharge treatment, flame treatment, plasma treatment and UV light irradiation treatment. Examples of the subbing layer include a layer containing gelatin or latex. The subbing layer can contain a known organic or inorganic electrically conductive material.

A substrate with a known backing layer coated can be used in order to control slippage of a rear surface of the substrate on the backing layer side, for example, in order to reduce friction between the rear surface and a plate cylinder of a printing press.

(Image Formation Layer)

The image formation layer in the invention is a negative working image formation layer which is imagewise exposed to form image portions at exposed portions which receive printing ink, and form non-image portions at unexposed portions which are ink-repellent and water-retentive.

In the printing plate material of the invention comprising a hydrophilic support having a hydrophilic surface and provided thereon, an image formation layer, a reflection density of the surface on the image formation layer side is not less than 0.2 lower than that of the hydrophilic surface.

The reflection density of the surface on the image formation layer side, which is not less than 0.2 lower than that of the hydrophilic surface, is obtained by providing, on the hydrophilic support described above, a light-colored, preferably white image formation layer with low transparency, for example, an image formation layer containing white pigment.

In the invention, the reflection density of the surface on the image formation layer side is not less than 0.2 lower, preferably not less than 0.3 lower, and more preferably not less than 0.4 lower than that of the hydrophilic surface of the support. The above is obtained by appropriately adjusting a particle size or content in the image formation layer of white pigment described later, or a dry coating amount of the image formation layer.

(White Pigment)

The white pigment in the invention is in the form of white particles, where the pigment itself is a white particle or the pigment turns white in the particle form. The white pigment in the invention is one having a Hunter whiteness w of preferably not less than 70, more preferably 80, and still more preferably from 90 to 100. The Hunter whiteness w is represented by the following formula:
Hunter whiteness w=100−{(100−L*)²+a*²+b*²}^{1/2}
wherein L*, a*, and b* are values obtained by being measured through a spectrophotometer.

Examples of the white pigment include known white pigment (for example, silica, zinc oxide, calcium carbonate or titanium oxide), but the invention is not specifically limited thereto.

In the first and second embodiments, a white pigment having a high shielding power is preferably used in that the pigment content or the dry coating amount of the image formation layer can be reduced. The reduction of the white pigment content can relatively increase a content of another material in the image formation layer, resulting in high printing durability. The reduction of the dry coating amount of the image formation layer can reduce the heat content of the image formation layer, resulting in increase of sensitivity.

Examples of the white pigment having a high shielding power include titanium oxide as an inorganic pigment, and hollow polymer particles as an organic pigment. The hollow polymer particles are preferably used, since they are difficult to precipitate in the coating liquid. Examples of the hollow polymer particles include SX 866 (styrene-acryl polymer, outer diameter: 0.3 μm, inside diameter: 0.2 μm) produced by JSR Co., Ltd., and ROPAQUE series produced by Rom and Haas Co. Ltd.

The particle size of the white pigment particles is preferably from 0.05 to 2.0 μm, and more preferably from 0.1 to 1.0 μm, in view of shielding power and resolution.

The white pigment content of the image formation layer is preferably from 5 to 90% by weight, and more preferably from 30 to 80% by weight, in view of shielding power and printing durability. The dry coating amount of the image formation layer is preferably from 0.2 to 4 g/m², and more preferably from 0.3 to 1 g/m², in view of sensitivity and shielding power.

(Image Formation Material for Image Formation Layer)

The image formation layer in the invention is preferably a water-developable layer, which is exposed and is developed with water. The water-developable layer refers to an image formation layer at unexposed portions which can be removed with an aqueous solution with a pH of 6 to 9 containing not less than 99% by weight.

It is preferred that the image formation layer contains an image formation material, which changes the image formation layer from one capable of being removed from the hydrophilic layer with water before exposure to one incapable of being removed with water after exposure.

Hydrophobic heat melting materials, heat fusible materials, or isocyanate compounds described later are preferably used as such an image formation material. The heat melting materials or heat fusible materials are preferably used in the particle form

Heat melting particles are particularly particles having a low melt viscosity among thermoplastic materials, which are particles formed from materials generally classified into wax. The materials preferably have a softening point of from 40° C. to 120° C. and a melting point of from 60° C. to 150° C., and more preferably a softening point of from 40° C. to 100° C. and a melting point of from 60° C. to 120° C. A melting point less than 60° C. provides poor storage stability, while a melting point exceeding 150° C. provides poor ink receptivity.

Materials usable include paraffin, polyolefin, polyethylene wax, microcrystalline wax, and fatty acid wax. The molecular weight thereof is approximately from 800 to 10,000. A polar group such as a hydroxyl group, an ester group, a carboxyl group, an aldehyde group and a peroxide group may be introduced into the wax by oxidation to increase the emulsification ability. Moreover, stearoamide, linolenamide, laurylamide, myristylamide, hardened cattle fatty acid amide, parmitylamide, oleylamide, rice bran oil fatty acid amide, palm oil fatty acid amide, a methylol compound of the above-mentioned amide compounds, methylenebissteastearoamide and ethylenebissteastearoamide may be added to the wax to lower the softening point or to raise the working efficiency. A cumarone-indene resin, a rosin-modified phenol resin, a terpene-modified phenol resin, a xylene resin, a ketone resin, an acryl resin, an ionomer and a copolymer of these resins may also be usable.

Among them, polyethylene, microcrystalline, fatty acid ester and fatty acid are preferably contained. A high sensitive image formation can be performed since these materials each have a relative low melting point and a low melt viscosity. These materials each have a lubrication ability. Accordingly, even when a shearing force is applied to the surface layer of the printing plate precursor, the layer damage is minimized, and resistance to stain which may be caused by scratch is further enhanced.

The heat melting particles are preferably dispersible in water. The average particle size thereof is preferably from 0.01 to 10 μm, and more preferably from 0.1 to 3 μm, in view of on-press developability or resolution.

The composition of the heat melting particles may be continuously varied from the interior to the surface of the particles. The particles may be covered with a different material. Known microcapsule production method or sol-gel method can be applied for covering the particles.

The heat melting particle content of the image formation layer is preferably 1 to 90% by weight, and more preferably 5 to 80% by weight.

The heat fusible particles in the invention include thermoplastic hydrophobic polymer particles. Although there is no specific limitation to the upper limit of the softening point of the thermoplastic hydrophobic polymer, the softening point is preferably lower than the decomposition temperature of the polymer. The weight average molecular weight (Mw) of the thermoplastic hydrophobic polymer is preferably within the range of from 10,000 to 1,000,000.

Examples of the polymer constituting the polymer particles include a diene (co)polymer such as polypropylene, polybutadiene, polyisoprene or an ethylene-butadiene copolymer, a synthetic rubber such as a styrene-butadiene copolymer, a methyl methacrylate-butadiene copolymer or an acrylonitrile-butadiene copolymer; a (meth)acrylate (co)polymer or a (meth)acrylic acid (co)polymer such as polymethyl methacrylate, a methyl methacrylate-(2-ethylhexyl)acrylate copolymer, a methyl methacrylate-methacrylic acid copolymer, or a methyl acrylate-(N-methylolacrylamide); polyacrylonitrile; a vinyl acetate (co)polymer such as a polyvinyl acetate, a vinyl acetate-vinyl propionate copolymer, a vinyl acetate-2-hexylethyl acrylate copolymer or a vinyl acetate-ethylene copolymer; vinyl chloride (co)polymer; vinylidene chloride (co)polymer; and styrene (co)polymer. Among them, the (meth)acrylate polymer, the (meth)acrylic acid (co)polymer, the vinyl ester (co)polymer, the polystyrene and the synthetic rubbers are preferably used.

The polymer particles may be prepared from a polymer synthesized by any known method such as an emulsion polymerization method, a suspension polymerization method, a solution polymerization method and a gas phase polymerization method. The particles of the polymer synthesized by the solution polymerization method or the gas phase polymerization method can be produced by a method in which an organic solution of the polymer is sprayed into an inactive gas and dried, and a method in which the polymer is dissolved in a water-immiscible solvent, then the resulting solution is dispersed in water or an aqueous medium and the solvent is removed by distillation. In both of the methods, a surfactant such as sodium lauryl sulfate, sodium dodecylbenzenesulfate or polyethylene glycol, or a water-soluble resin such as poly(vinyl alcohol) may be optionally used as a dispersing agent or stabilizing agent.

The heat fusible particles are preferably dispersible in water. The average particle size of the heat fusible particles is preferably from 0.01 to 10 μm, and more preferably from 0.1 to 3 μm.

Further, the composition of the heat fusible particles may be continuously varied from the interior to the surface of the particles. The particles may be covered with a different material. As a covering method, known methods such as a microcapsule method and a sol-gel method are usable.

The thermoplastic particle content of the image formation layer is preferably 1 to 90% by weight, and more preferably 5 to 80% by weight.

Microcapsules used include those encapsulating oleophilic materials disclosed in Japanese Patent O.P.I. Publication Nos. 2002-2135 and 2002-19317.

The average microcapsule size of the microcapsules is preferably from 0.1 to 10 μm, more preferably from 0.3 to 5 μm, and still more preferably from 0.5 to 3 μm.

The thickness of the microcapsule wall is preferably from 1/100 to ⅕ of the microcapsule size, and more preferably from 1/50 to 1/10 of the microcapsule size.

The microcapsule content of the image formation layer is preferably 5 to 100% by weight, more preferably 20 to 95% by weight, and still more preferably 40 to 90% by weight. As the materials for the microcapsule wall, known materials can be used. As a method of manufacturing the microcapsules, known methods can be used. The materials for the microcapsule wall and the manufacturing method of the microcapsule wall can be applied which are disclosed in for example, Tamotsu Kondo, Masumi Koishi, “New Edition Microcapsule, Its Manufacturing Method, Properties And Application”, published by Sankyo Shuppan Co., Ltd., or disclosed in literatures cited in it.

Microcapsules encapsulating oleophilic materials disclosed in Japanese Patent O.P.I. Publication Nos. 2002-2135 and 2002-19317 are preferably used as the image formation material.

A blocked isocyanate compound described later is preferably used as the image formation material.

The isocyanate compound is preferably used in the aqueous dispersion to give water removability.

The aqueous dispersion of the blocked isocyanate compound used in the image formation layer will be explained below.

The present invention will be explained in detail below.

The planographic printing plate of the invention is a printing plate material comprising a support and provided thereon, a hydrophilic layer and an image formation layer, wherein the image formation layer contains a blocked isocyanate compound, which is a reaction product of an isocyanate compound, a polyol, and an isocyanate group-blocking material, wherein the image formation layer is formed by coating on the support an aqueous image formation layer coating liquid containing the blocked isocyanate compound.

(Image Formation Layer)

The image formation layer in the invention is imagewise heated whereby a heated image formation layer forms an ink receptive image, and an unheated image formation layer is removed to reveal a hydrophilic surface of the hydrophilic layer. Thus, a printing plate is obtained. The imagewise heating is carried out according to a heat source or heat generated due to laser exposure, and preferably according to heat generated due to laser exposure. The image formation layer contains a blocked isocyanate compound. The blocked isocyanate compound is heated to release a blocking material and reproduce an isocyanate group, which reacts with the polyol or the support. Thus, the heated image formation layer forms an image which is ink receptive.

The content of the blocked isocyanate compound in the image formation layer is preferably not less than 50% by weight, more preferably from 70 to 100% by weight, and still more preferably from 80 to 100% by weight.

The image formation layer in the invention is formed by coating, on a support, an aqueous image formation layer coating liquid containing a blocked isocyanate compound. The aqueous image formation layer coating liquid in the invention contains water in an amount of not less than 95% by weight.

The blocked isocyanate compound is preferably contained in the particle form in the aqueous image formation layer coating liquid. That is, the aqueous image formation layer coating liquid in the invention is preferably an aqueous dispersion of the blocked isocyanate compound.

The blocked isocyanate compound is a reaction product of an isocyanate compound, a polyol, and an isocyanate group-blocking material (hereinafter also referred to as a blocking material).

(Isocyanate Compound)

Examples of the isocyanate compound include an aromatic polyisocyanate such as diphenylmethane diisocyanate (MDI), tolylene diisocyanate (TDI), polyphenylpolymethylene polyisocyanate (crude MDI), or naphthalene diisocyanate (NDI); an aliphatic polyisocyanate such as 1,6-hexamethylene diisocyanate (HDI), or lysine diisocyanate (LDI); an alicyclic polyisocyanate such as isophorone diisocyanate (IPDI), dicyclohexylmethane diisocyanate (hydrogenation MDI), or cyclohexylene diisocyanate; an aromatic aliphatic Polyisocyanate such as xylylene diisocyanate (XDI), or tetramethylxylene diisocyanate (TMXDI); and their modified compounds such as those having a burette group, an isocyanurate group, a carbodiimide group, or an oxazolidine group); and a urethane polymer having an isocyanate group in the molecular end, which is comprised of an active hydrogen-containing compound with a molecular weight of from 50 to 5,000 and the polyisocyanate described above. The polyisocyanates described in Japanese Patent O.P.I. Publication No. 10-72520 are preferably used.

Among those polyisocyanates, tolylene diisocyanate is especially preferred in view of high reactivity.

(Blocking Material)

Examples of the blocking material include an alcohol type blocking material such as methanol, or ethanol; a phenol type blocking material such as phenol or cresol; an oxime type blocking material such as formaldoxime, acetaldoxime, methyl ethyl ketoxime, methyl isobutyl ketoxime, cyclohexanone oxime, acetoxime, diacetyl monoxime, or benzophenone oxime; an acid amide type blocking material such as acetanilide, ε-caprolactam, or γ-butyrolactam; an active methylene containing blocking material such as dimethyl malonate or methyl acetoacetate; a mercaptan type blocking material such as butyl mercaptan; an imide type blocking material such as succinic imide or maleic imide; an imidazole type blocking material such as imidazole or 2-methylimidazole; a urea type blocking material such as urea or thiourea; an amine type blocking material such as diphenylamine or aniline; and an imine type blocking material such as ethylene imine or polyethylene imine. Among these, the oxime type blocking material is preferred.

It is preferred that the content of the blocking material is such an amount that the amount of the active hydrogen of the blocking material is from 1.0 to 1.1 equivalent of the isocyanate group of the isocyanate compound. It is preferred that when an active hydrogen-containing additive such as a polyol described later is used in combination, the content of the blocking material is such an amount that the total amount of the active hydrogen of the blocking material and the additive is from 1.0 to 1.1 equivalent of the isocyanate group of the isocyanate compound. The amount less than 1.0 equivalent of the active hydrogen produces an unreacted isocyanate group, while the amount exceeding 1.1 equivalent of the active hydrogen results in excess of blocking material, which is undesirable.

The releasing temperature of blocking material from the blocked isocyanate compound is preferably from 80 to 200° C., more preferably from 80 to 160° C., and still more preferably from 80 to 130° C.

(Polyol)

The blocked isocyanate compound in the invention is preferably an adduct of an isocyanate with a polyol.

The adduct derived from the polyol can improve storage stability of the blocked isocyanate compound. When the image formation layer containing the adduct is imagewise heated, the resulting image increases image strength, resulting in improvement of printing durability.

Examples of the polyol include a polyhydric alcohol such as propylene glycol, triethylene glycol, glycerin, trimethylol methane, trimethylol propane, pentaerythritol, neopentyl glycol, 1,6-hexylene glycol, hexamethylene glycol, xylylene glycol, sorbitol or sucrose; polyether polyol which is prepared by polymerizing the polyhydric alcohol or a polyamine with ethylene oxide and/or propylene oxide; polytetramethylene ether polyol; polycarbonate polyol; polycaprolactone polyol; polyester polyol, which is obtained by reacting the above polyhydric alcohol with polybasic acid such as adipic acid, phthalic acid, isophthalic acid, terephthalic acid, sebatic acid, fumaric acid, maleic acid, or azelaic acid; polybutadiene polyol; acrylpolyol; castor oil; a graft copolymer polyol prepared by graft polymerization of a vinyl monomer in the presence of polyether polyol or polyester polyol; and an epoxy modified polyol. Among these, a polyol having a molecular weight of from 50 to 5,000 such as propylene glycol, triethylene glycol, glycerin, trimethylol methane, trimethylol propane, pentaerythritol, neopentyl glycol, 1,6-hexylene glycol, butane diol, hexamethylene glycol, xylylene glycol, or sorbitol is preferred, and a low molecular weight polyol having a molecular weight of from 50 to 500 is especially preferred.

It is preferred that the content of the polyol is such an amount that the amount of the hydroxyl group of the polyol is from 0.1 to 0.9 equivalent of the isocyanate group of the isocyanate compound. The above range of the hydroxyl group of the polyol provides improved storage stability of the blocked isocyanate compound.

(Blocking Method)

As a blocking method of an isocyanate compound, there is, for example, a method comprising the steps of dropwise adding a blocking material to the isocyanate compound at 40 to 120° C. while stirring under an anhydrous condition and an inert gas atmosphere, and after addition, stirring the mixture solution for additional several hours. In this method, a solvent can be used, and a known catalyst such as an organometallic compound, a tertiary amine or a metal salt can be also used. Examples of the organometallic compound include a tin catalyst such as stannous octoate, dibutyltin diacetate, or dibutyltin dilaurate; and a lead catalyst such as lead 2-ethylhexanoate. Examples of the tertiary amine include triethylamine, N,N-dimethylcyclohexylamine, triethylenediamine, N,N′-dimethylpiperazine, and diazabicyclo (2,2,2)-octane. Examples of the metal salt include cobalt naphthenate, calcium naphthenate, and lithium naphthenate. These catalysts are used in an amount of ordinarily from 0.001 to 2% by weight, and preferably from 0.01 to 1% by weight based on 100 parts by weight of isocyanate compound.

The blocked isocyanate compound in the invention, which is a reaction product of an isocyanate compound, a polyol, and a blocking material, is obtained by reacting the isocyanate compound with the polyol, and then reacting a residual isocyanate group with the blocking material or by reacting the isocyanate compound with the blocking material, and then reacting a residual isocyanate group with the polyol. The blocked isocyanate compound in the invention has an average molecular weight of preferably from 500 to 2,000, and more preferably from 600 to 1,000. This range of the molecular weight provides good reactivity and storage stability.

(Manufacture of Aqueous Dispersion)

The blocked isocyanate compound obtained above is added to an aqueous solution containing a surfactant, and vigorously stirred in a homogenizer to obtain an aqueous dispersion of blocked isocyanate compound. Examples of the surfactant include an anionic surfactant such as sodium dodecylbenzene sulfonate, sodium lauryl sulfate, sodium dodecyldiphenylether disulfonate, or sodium dialkyl succinate sulfonate; a nonionic surfactant such as polyoxyethylenealkyl ester or polyoxyethylenealkyl aryl ester; and an amphoteric surfactant including an alkyl betaine such as lauryl bataines or stearyl betaine and an amino acid such as lauryl β-alanine, lauryldi(aminoethyl)glycine, or octyldi(aminoethyl)glycine. These surfactant may be used singly or in combination. Among these, the nonionic surfactant is preferred.

The solid content of the aqueous dispersion of the blocked isocyanate compound is preferably from 10 to 80% by weight. The surfactant content of the aqueous dispersion is preferably from 0.01 to 20% by weight based on the solid content of the aqueous dispersion.

When an organic solvent is used in a blocking reaction of the isocyanate compound, the organic solvent can be removed from the resulting aqueous dispersion.

As other image formation materials, there can be used thermosensitive or photopolymerizable materials disclosed in WO-0221215 and Japanese Patent O.P.I. Publication No. 2004-21217, and thermosensitive switchable polymers disclosed in JP 2003-527978 and JP 2004-501800.

(Water-Soluble Compound)

The image formation layer in the invention preferably contains a water-soluble compound. The water-soluble compound in the invention is a compound which is dissolved in an amount of not less than 0.5 g in 100 g of 25° C. water. A water-soluble compound which is dissolved in an amount of not less than 2 g in 100 g of 25° C. water is preferred in providing good water developability, and it is preferred in maintaining strength of the image formation layer that the water-soluble compound in the invention is a solid at 20° C.

Examples of the water-soluble compound are listed below.
Oligosaccharides: trehalose, sucrose, maltose, cyclodextrin, etc.
Water-soluble polymers: polysaccharides (starches, celluloses, polyuronic acid, pullulan, chitosan and their derivatives, polyethylene oxide, polypropylene oxide, polyvinyl alcohol, polyethylene glycol (PEG), polyvinyl ether, polyacrylic acid, polyacrylic acid salt, polyacrylamide, and polyvinyl pyrrolidone.
   (Another Material Optionally Contained in the Image Formation Layer)

The image formation layer in the invention, containing the blocked isocyanate compound as the image formation material, can contain a catalyst which accelerates release of blocking material from the blocked isocyanate compound or reaction of the reproduced isocyanate group with a functional group. Examples of the catalyst include a known catalyst such as an organometallic compound, a tertiary amine or a metal salt.

(Light-to-Heat Conversion Material)

The image formation layer in the invention can contain a light-to-heat conversion material.

Examples of the light-to-heat conversion material include pigments or dyes such as carbon black, graphite, metal particles, and metal oxide particles. In order to obtain a preferred reflection density of the image formation layer, a dye as described later is preferred. An infrared absorbing dye is preferably used as the dye.

In order to obtain a surface on the image formation layer side with a reflection density as defined above, it is necessary that the content of the infrared absorbing dye in the image formation layer be adjusted, since the dye changes a reflection density of the image formation layer surface depending on its color density. The content of the infrared absorbing dye in the image formation layer is preferably from 0.001 g/m² to less than 0.2 g/m², and more preferably from 0.001 g/m² to less than 0.05 g/m².

A dye having a low absorption to visible light is preferably used.

Examples of the infrared absorbing dye include a general infrared absorbing dye such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound. Exemplarily, the light-to-heat conversion materials include compounds disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These compounds may be used singly or in combination.

Compounds described in Japanese Patent O.P.I. Publication Nos. 11-240270, 11-265062, 2000-309174, 2002-49147, 2001-162965, 2002-144750, and 2001-219667 can be preferably used.

The image formation layer in the invention can contain a surfactant. A silicon-contained surfactant, a fluorine-contained surfactant or an acetylene glycol surfactant can be used, and a silicon-contained surfactant or an acetylene glycol surfactant is preferred in minimizing stain occurrence. The surfactant content of the image formation layer (the solid component of the coating liquid) is preferably from 0.01 to 3% by weight, and more preferably from 0.03 to 1% by weight.

The image formation layer in the invention can contain an acid (phosphoric acid or acetic acid) or an alkali (sodium hydroxide, silicate, or phosphate) to adjust pH. The image formation layer in the invention can contain a lubricant. Incorporation of the lubricant to the image formation layer can enhance anti-scratch property (scratch is likely to produce stain at non-image portions).

Examples of the lubricant include known waxes. Among the waxes, fatty acid amide, fatty acid calcium ester, or fatty acid zinc ester is preferred, each having low ink receptivity. The lubricant is preferably added in a dispersion to the aqueous coating liquid.

The lubricant content of the image formation layer is preferably from 0.1 to 30% by weight, and more preferably from 0.5 to 15% by weight.

### Third Embodiment

The third embodiment is characterized in that in an image formation process employing a printing plate material comprising a hydrophilic support having a hydrophilic surface, and provided thereon, an image formation layer, in which the hydrophilic surface of the support has a reflection density of not less than 1.0, and the reflection density of the surface on the image formation layer side is not less than 0.2 lower than that of the hydrophilic surface, the process comprises the steps of imagewise exposing the printing plate material, so that a reflection density of the surface on the image formation layer side is not less than 0.2 higher at exposed portions than at unexposed portions. The process comprises the following steps.

In this process, the imagewise exposure is carried out at an exposure energy of preferably from 50 to 1000 mJ/cm², and the light source used for imagewise exposure is one emitting light with a wavelength of preferably from 700 to 1500 nm (for example, a semiconductor laser).
a. A step of preparing a support having a hydrophilic surface having a reflection density of not less than 1.0.
b. A step of providing, on the hydrophilic support, an image formation layer so that a surface on the image formation layer side has a reflection density not less than 0.2 lower than that of the hydrophilic surface to prepare a printing plate material.
c. A step of imagewise exposing the printing plate material to fix the exposed image formation layer onto the support, so that a reflection density of the surface on the image formation layer side is not less than 0.2 higher at exposed portions than at unexposed portions.

In the third embodiment, an image formation process is preferred which employs a printing plate material comprising a hydrophilic support having a hydrophilic surface, and provided thereon, an image formation layer, in which the hydrophilic surface of the hydrophilic support has a reflection density of not less than 1.0, and a reflection density of the surface on the image formation layer side is not less than 0.5 lower than that of the hydrophilic surface, the process comprising the steps of imagewise exposing the printing plate material, so that a reflection density of the surface on the image formation layer side is not less than 0.4 higher at exposed portions than at unexposed portions.

As the third embodiment, there is, for example, an image formation process comprising the steps of providing a black hydrophilic layer on a substrate in which the hydrophilic layer surface has a reflection density of not less than 1.0, and preferably not less than 1.5, forming a white image formation layer on the hydrophilic layer surface to obtain a printing plate material, in which a reflection density of the surface on the image formation layer side is not less than 0.2 lower than that of the hydrophilic surface, and imagewise exposing the printing plate material so that a reflection density of the surface on the image formation layer side is not less than 0.2 higher at exposed portions than at unexposed portions. This is realized by adding white heat melting particles to the image formation layer. In this case, the image formation layer being exposed to infrared laser, the white heat melting particles heat-melt to increase light transmittance of the image formation layer, which can provide a reflection density of the surface on the image formation layer side being not less than 0.2 higher at exposed portions than at unexposed portions.

A reflection density of the surface on the image formation layer side of not less than 0.2 lower, and preferably not less than 0.5 lower than, that of the hydrophilic surface, is obtained by appropriately adjusting kinds, a particle size or a content in the image formation layer of the white heat melting particles, or a dry coating amount of the image formation layer.

A reflection density of the surface on the image formation layer side, which is not less than 0.2 higher, and preferably not less than 0.4 higher at exposed portions than at unexposed portions, can be obtained by appropriately adjusting a melting point or a particle size of the white heat melting particles in the image formation layer, or a dry thickness of the image formation layer.

(White Heat Melting Particles)

As the white heat melting particles, organic particles having a melting point of from 60 to 150° C. is preferably used.

A hollow structure or a core-shell structure comprised of materials with a different refractive index can increase whiteness of the white heat melting particles. As the white heat melting particles, particles of waxes such as paraffin wax, polyethylene wax, carnauba wax, and microcrystalline wax are preferably used.

The particle size of the white heat melting particles is preferably from 0.1 to 10.0 μm, more preferably from 0.2 to 5.0 μm, and still more preferably from 0.3 to 2.0 μm, in view of resolution, sensitivity, and whiteness.

The white heat melting particle content of the image formation layer is preferably from 40 to 100% by weight, and more preferably from 60 to 98% by weight.

In the invention, the white heat melting particles themselves function as image formation material, an image formation layer containing 100% by weight of the white heat melting particles is possible. The white heat melting particles can be used in combination with the image formation materials as described above other than the white heat melting particles.

In order to improve on-press developability of printing plate material, which is a property that an image formation layer at unexposed portions is removed with a dampening water and/or printing ink on a plate cylinder of a printing press, the content of the water-soluble compound described above in the image formation layer is preferably from 0.1 to 40% by weight.

The dry coating amount of the image formation layer is preferably from 0.2 to 4 g/m². However, the dry coating amount of the image formation layer is more preferably from 0.2 to 2 g/m², and still more preferably from 0.3 to 1 g/m², in view of shielding power and on-press developability.

The image formation layer of the third embodiment is the image formation layer as described above, and the image formation layer is preferably an image formation layer capable of being developed on a plate cylinder of a printing press.

Herein, “an image formation layer capable of being developed on a plate cylinder of a printing press” refers to an image formation layer, which, after imagewise exposure, is capable of being removed with a dampening water and/or printing ink at unexposed portions during printing.

In the third embodiment, the same support as denoted in the first and second embodiments can be used.

(Exposure)

In the invention, exposure is preferably carried out employing a laser. Image formation employing a thermal laser as the laser is especially preferred.

For example, scanning exposure is preferred which is carried out employing an infrared or near-infrared laser which emits light having a wavelength of from 700 to 1500 nm. As the laser, a gas laser can be used, but a semiconductor laser, which emits near-infrared light, is preferably used.

The scanning exposure device may be any as long as it can form an image on the surface of a printing plate material employing the semiconductor laser, based on image formation signal from a computer.

Generally, the scanning exposure devices include those employing the following processes.

(1) a process in which a plate material provided on a fixed horizontal plate is scanning exposed in two dimensions, employing one or several laser beams.

(2) a process in which the surface of a plate material provided along the inner peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

(3) a process in which the surface of a plate material provided along the outer peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder. The process (3) is used particularly when a printing plate material mounted on a plate cylinder of a printing press is scanning exposed

### EXAMPLES

The present invention will be explained below employing the following examples. In the examples, “parts” is parts by weight, unless otherwise specifically specified.

Preparation of Substrate 1 (Substrate for Coating a Hydrophilic Layer)

Both surfaces of a 175 μm thick biaxially stretched polyester sheet were corona discharged under condition of 8 W/m²·minute. Then, the surface on one side of the resulting sheet was coated with the following subbing layer coating solution a to give a first subbing layer with a dry coating amount of 0.8 μm, and then coated with the following subbing layer coating solution b to give a second subbing layer with a dry thickness of 0.1 μm, while the first subbing layer was corona discharged under condition of 8 W/m²·minute, each layer was dried at 180° C. for 4 minutes (subbing layer A was formed).

Successively, the surface on the other side of the resulting sheet was coated with the following subbing layer coating solution c to give a third subbing layer with a dry thickness of 0.8 μm, and then coated with the following subbing layer coating solution d to give a fourth subbing layer with a dry thickness of 1.0 μm, while the third subbing layer was corona discharged under condition of 8 W/m²·minute, each layer was dried at 180° C. for 4 minutes (subbing layer B was formed. Thus, substrate 1 having a subbing layer on each surface was prepared. The substrate 1 had a surface electric resistance at 25° C. and 25% RH of 10⁸ Ω.

| <<Subbing layer coating solution a>> | | |
|---|---|---|
| Latex of styrene/glycidyl methacrylate/butyl acrylate | 6.3 | parts |
| (60/39/1) copolymer (Tg = 75° C.) | | |
| (in terms of solid content) | | |
| Latex of styrene/glycidyl methacrylate/butyl acrylate | 1.6 | parts |
| (20/40/40) copolymer | | |
| (in terms of solid content) | | |
| Anionic surfactant S-1 | 0.1 | parts |
| Water | 92.0 | parts |
| <<Subbing layer coating solution b>> | | |
| Gelatin | 1 | part |
| Anionic surfactant S-1 | 0.05 | parts |
| Hardener H-1 | 0.02 | parts |
| Matting agent (Silica particles | 0.02 | parts |
| with an average particle size of 3.5 μm) | | |
| Antifungal agent F-1 | 0.01 | parts |
| Water | 98.9 | parts |

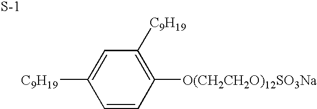

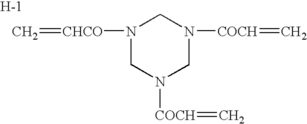

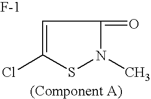

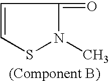

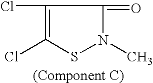

(Component A):(Component B):(Component C) = 50:46:4 (by mole)

| | | |
|---|---|---|
| <<Subbing layer coating solution c>> | | |
| Latex of styrene/glycidyl methacrylate/butyl acrylate | 0.4 | parts |
| (20/40/40) copolymer | | |
| Latex of styrene/glycidyl meethacrylate/butyl | 7.6 | parts |
| acrylate/acetoacetoxyethyl methacrylate (39/40/20/1) | | |
| copolymer | | |
| Anionic surfactant S-1 | 0.1 | parts |
| Water | 91.9 | parts |
| <<Subbing layer coating solution d>> | | |
| Conductive composition of | 6.4 | parts |
| *Component d-1/**Component d-2/***Component d-3 | | |
| (= 66/31/1) | | |
| Hardener H-2 | 0.7 | parts |
| Anionic surfactant S-1 | 0.07 | parts |
| Matting agent (silica particles | 0.03 | parts |
| with an average particle size of 3.5 μm) | | |
| Water | 92.8 | parts |

*Component d-1:
Copolymer of sodium styrene sulfonate/maleic acid (50/50)
(Anionic polymer)
**Component d-2:
Latex of styrene/glycidyl methacrylate/butyl acrylate
(40/40/20) copolymer
***Component d-3:
Copolymer of styrene/sodium isoprene sulfonate
(80/20) (Polymer surfactant)
H-2
Mixture of three compounds below

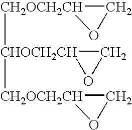

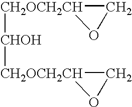

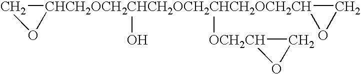

Preparation of Substrate 2

A 0.24 mm thick aluminum plate (material 1050, refining H16) was immersed in an aqueous 1% by weight sodium hydroxide solution at 50° C. to give an aluminum dissolution amount of 2 g/m², washed with water, immersed in an aqueous 0.1% by weight hydrochloric acid solution at 25° C. for 30 seconds for neutralizing, and then washed with water.

Successively, the aluminum plate was subjected to an electrolytic surface-roughening treatment in an electrolytic solution containing 10 g/liter of hydrochloric acid and 0.5 g/liter of aluminum at a peak current density of 50 A/dm² employing an alternating current with a sine waveform, in which the distance between the plate surface and the electrode was 10 mm. The electrolytic surface-roughening treatment was divided into 8 treatments, in which the quantity of electricity used in one treatment (at a positive polarity) was 40 C/dm², and the total quantity of electricity used (at a positive polarity) was 320 C/dm². Standby time of 4 seconds, during which no surface-roughening treatment was carried out, was provided after each of the separate electrolytic surface-roughening treatments.

Subsequently, the resulting aluminum plate was immersed in an aqueous 1% by weight sodium hydroxide solution at 50° C. and etched to give an aluminum etching amount (including smut produced on the surface) of 2 g/m², washed with water, neutralized in an aqueous 10% by weight sulfuric acid solution at 25° C. for 10 seconds, and washed with water. Subsequently, the aluminum plate was subjected to anodizing treatment in an aqueous 20% by weight sulfuric acid solution at a constant voltage of 20 V, in which a quantity of electricity of 150 C/dm² was supplied, and washed with water.

The washed surface of the plate was squeegeed, and the plate was immersed in an aqueous 0.1% by weight ammonium acetate solution (adjusted to pH 9, employing a sodium hydroxide solution) at 90° C. for 60 seconds, washed with water, and dried at 80° C. for 5 minutes. Thus, substrate 2 was obtained.

The surface roughness Ra of the substrate 2 was 0.35 μm.

[Measurement of Surface Roughness]

A platinum-rhodium layer with a thickness of 1.5 nm are vacuum-deposited onto a sample surface, and surface roughness is measured under condition of a magnification of 20, employing a non-contact three dimensional surface roughness measuring device RST plus produced by WYKO Co., Ltd., (in which the measurement area is 222.4 μm×299.4 μm). The resulting measurement is subjected to slope correction and to filtering treatment of Median Smoothing. Five portions of each sample are measured and the average of the measurements is defined as surface roughness Ra of the sample.

### Example 1

(Preparation of Hydrophilic Support having a Hydrophilic Surface)

Materials as shown in Table below were sufficiently mixed while stirring at a rotation frequency of 5,000 for 5 minutes, employing a homogenizer, and filtered to obtain a hydrophilic layer coating liquid 1 with a solid content of 30% by weight. The pH of this coating liquid was 9.5.

TABLE 1
Composition of Hydrophilic Layer Coating Liquid 1 (Numerical values
in Table 1 are parts by weight, unless otherwise specified.)

| | Coating |
|---|---|
| | Liquid 1 |
| | Compo- |
| Materials | sition |
| Light-to-heat conversion metal oxide particles | 13.80 |
| Black iron oxide particles ABL-207 (produced by | |
| Titan Kogyo K.K., octahedral form, average particle | |
| size: 0.2 μm, acicular ratio: substantially 1, | |
| specific surface area: 6.7 m²/g, Hc: 9.95 kA/m, | |
| σs: 85.7 Am²/kg, σr/σs: 0.112) | |
| Colloidal silica (alkali type): Snowtex XS | 69.60 |
| (particle size: 4-6 μm, solid content: 20% by | |
| weight, produced by Nissan Kagaku Co., Ltd.) | |
| Aqueous 10% by weight sodium | 1.50 |
| phosphate · dodecahydrate (Reagent produced by Kanto | |
| Kagaku Co., Ltd.) solution | |
| Chitosan particle aqueous dispersion (average | 10.34 |
| particle size: 2 μm, solid content: 6% by weight) | |
| Porous metal oxide particles Silton JC50 (porous | 1.50 |
| aluminosilicate particles having an average | |
| particle size of 5 μm, produced by Mizusawa Kagaku | |
| Co., Ltd.) | |
| Surfactant: Surfinol 465 (produced by Air Products | 3.00 |
| Co., Ltd.,) 1% by weight aqueous solution | |
| Pure water | 0.26 |

The hydrophilic layer coating liquid was coated on the substrate as shown in Table 3 (on the subbing layer A of the substrate 1 and on the roughened surface of the substrate 2), employing a wire bar, and dried at 120° C. for 3 minutes to obtain a hydrophilic layer with a dry coating amount as shown in Table 3. The resulting substrate was further subjected to aging at 60° C. for 24 hours to obtain a hydrophilic support having a hydrophilic surface.

The reflection density of the hydrophilic surface of the hydrophilic support was one determined based on absolute white, employing a reflection densitometer Macbeth D 196 produced by Gretag-Macbeth Co., Ltd. The results are shown in Table 1.

A hydrophilic support sample employing the substrate 1 being provided on a base in which four coated paper sheets used in printing are superposed one over the other, the reflection density of the hydrophilic surface was determined.

(Preparation of Printing Plate Material Samples Comprising a Support Having a Hydrophilic Surface and Provided Thereon, an Image Formation Layer)

Materials as shown in Table below were sufficiently mixed while stirring, and filtered to obtain image formation layer coating liquids 1 through 3 with a solid content of 10% by weight.

TABLE 2
Composition of Image Formation Layer Coating Liquids
1 through 3 (Numerical values in Table 2 are parts
by weight, unless otherwise specified.)

| | | Image | Image | Image |
|---|---|---|---|---|
| | | formation | formation | formation |
| | | layer | layer | layer |
| | | coating | coating | coating |
| Materials | | liquid 1 | liquid 2 | liquid 3 |
| White pigment | (a) | | 4.50 | 6.00 |
| Heat fusible | (b) | 14.44 | 7.88 | |
| particles | | | | |
| Blocked | (c) | 4.55 | 2.27 | 6.82 |
| isocyanate | | | | |
| compound | | | | |
| Water-soluble | (d) | 5.00 | 3.33 | 3.33 |
| compound | | | | |

| | | | |
|---|---|---|---|
| Pure water | 76.01 | 82.12 | 83.85 |

(a): Hollow styrene-acryl polymer particles SX 866 (A) (outer diameter: 0.3 μm, inside diameter: 0.2 μm) produced by JSR Co., Ltd.
(b): Acrylonitrile · styrene · alkyl acrylate · methacrylic acid copolymer emulsion Yodosol GD87B (average particle size: 90 nm, Tg: 60° C., solid content: 45% by weight, produced by Nippon NCS Co., Ltd.)
(c): Aqueous dispersion (with a solid content of 44% by weight) of blocked isocyanate compound WB-700 (produced by Mitsui Takeda Chemical Co., Ltd., isocyanate compound: trimethylolpropane adduct of TDI, blocking material: oxime type, releasing temperature: 120° C.)
(d): Sodium polyacrylate, AQUALIC DL522 (produced by Nippon Shokubai Co., Ltd., solid content: 30% by weight)

The image formation layer coating liquid was coated on the hydrophilic support with constitution as shown in Table 3, employing a wire bar, dried at 55° C. for 3 minutes, and further subjected to aging at 50° C. for 48 hours to obtain a printing plate material sample. Thus, printing plate material samples 1 through 11 were obtained.

The reflection density of the image formation layer surface of the resulting printing plate material sample was measured in the same manner as above. The results are shown in Table 3.

(A Step of Imagewise Exposing the Printing Plate Material Employing an Infrared Laser to Fix the Image Formation Layer at Exposed Portions onto the Hydrophilic Surface of the Hydrophilic Support)

Each of the resulting printing plate material samples was mounted on an exposure drum, and imagewise exposed. The exposure was carried out employing an infrared laser (having a wavelength of 830 nm and a beam spot diameter of 18 μm) at a resolution of 2400 dpi (“dpi” herein shows the number of dots per 2.54 cm) and at a screen line number of 175 to form an image. An image pattern used for the exposure had a solid image, a dot image with a dot area of 1 to 99%, and a line and space image of 2400 dpi. The exposure energy was changed from 200 to 500 mJ/cm² at an interval of 50 mJ/cm², and an image was formed at each exposure energy.

(A Step of Developing the Exposed Printing Plate Material Sample with an Aqueous Solution to Remove an Image Formation Layer at Unexposed Portions)

The exposed printing plate material sample was developed with flowing water while rubbing the image formation layer with a sponge to remove an image formation layer at unexposed portions, and dried at 55° C. for 5 minutes to obtain a printing plate sample.

Evaluation of Sensitivity

The surface of the developed printing plate material samples was observed through a loupe, and the lowest exposure energy, at which an image with a 1% dot area was fully reproduced, was determined, and defined as sensitivity. The results are shown in Table 3. In Table 3, a printing plate material sample, in which an image with a 1% dot area was not reproduced even at an exposure energy of 500 mJ/cm², is described as poor sensitivity.

Evaluation of Visualization

With respect to the resulting printing plate sample, a reflection density of image portions (portions exposed at exposure energy providing sensitivity as defined above) and non-image portions (unexposed portions where the hydrophilic surface was disclosed) was measured in the same manner as above, and an absolute value of a reflection density difference |ΔD| of the image formation layer surface between the image portions and non-image portions was determined. The results are shown in Table 3.

Further, visualization was visually observed and evaluated according to the following criteria:
A: Excellent, B: Good, C: recognizable level, D: scarcely recognizable level, E: unrecognizable level
   Evaluation of Printability

The resulting printing plate sample being mounted on a plate cylinder of a printing press, DAIYA 1F-1 produced by Mitsubishi Jukogyo Co., Ltd., printing was carried out in the same printing condition and printing sequence as a conventional PS plate, employing coated paper, a dampening solution, a 2% by weight solution of Astromark 3 (produced by Nikken Kagaku Kenkyusyo Co., Ltd.) and printing ink (Toyo King Hyunity M Magenta, produced by Toyo Ink Manufacturing Co. Ltd.).

Each printing plate sample exhibited good ink receptivity at solid image portions, without stain at non-image portions.

Evaluation of Small Dot Image Strength (Printing Durability)

Printing was carried out to obtain five thousand prints, employing a printing plate sample, which was obtained by carrying out imagewise exposing the printing plate material sample at exposure energy providing sensitivity as defined above (a sample providing poor sensitivity was exposed at 500 mJ/cm²), and developing it. Reproduction of an image with a 1% dot area in the five thousandth print was observed through a loupe. Printing durability was evaluated according to the following criteria:
A: Less than one quarter of the total number of dots was lacking.
B: One quarter to less than a half of the total number of dots was lacking.
C: Not less than a half of the total number of dots was lacking.

The results are shown in Table 3.

TABLE 3

| | | | | | | | | Absolute value | | | |
|---|---|---|---|---|---|---|---|---|---|---|---|
| | | Dry | | | Dry | | | of density | | | |
| | | coating | Reflection | | coating | Reflection | | difference | | | |
| Printing | | amount | density | Image | amount | density of | | \|ΔD\| | | | |
| plate | | of | of | formation | of image | image | | between image | | Small | |
| material | Sub- | hydrophilic | hydrophilic | layer | formation | formation | Sensi- | portions | | dot | |
| sample | strate | layer | layer | coating | layer | layer side | tivity | and non-image | Visual- | image | |
| No. | No. | (g/m²) | surface | liquid | (g/m²) | surface | (mJ/cm²) | portions | ization | strength | Remarks |
| 1 | 1 | 5.0 | 1.65 | 1 | 0.5 | 1.60 | 350 | 0.05 | E | A | Comp. |
| 2 | 1 | 5.0 | 1.65 | 2 | 0.7 | 1.05 | 350 | 0.60 | B | A | Inv. |
| 3 | 1 | 4.0 | 1.50 | 3 | 0.6 | 0.80 | 350 | 0.70 | B | A | Inv. |
| 4 | 1 | 2.8 | 1.15 | 2 | 0.4 | 0.90 | 350 | 0.25 | C | A | Inv. |
| 5 | 2 | 1.8 | 0.90 | 2 | 0.8 | 0.65 | *1 | 0.25 | C | C | Comp. |
| 6 | 2 | 5.5 | 2.05 | 1 | 0.7 | 1.90 | 400 | 0.15 | D | A | Comp. |
| 7 | 2 | 5.5 | 2.05 | 3 | 0.9 | 1.10 | 400 | 0.95 | A | A | Inv. |
| 8 | 2 | 3.0 | 1.55 | 2 | 0.6 | 1,05 | 350 | 0.50 | B | A | Inv. |
| 9 | 2 | 6.5 | 2.10 | 3 | 1.0 | 1.05 | 400 | 1.05 | A | A | Inv. |
| 10 | 2 | 6.5 | 2.10 | 3 | 1.2 | 0.95 | 450 | 1.15 | A | A | Inv. |
| 11 | 2 | 6.5 | 2.10 | 2 | 0.4 | 1.75 | 300 | 0.35 | B | A | Inv. |

Inv.: Inventive,
Comp.: Comparative,
*1: Poor sensitivity

As is apparent from Table 3, the inventive sample, comprising an image formation layer capable of being developed with an aqueous solution, and the inventive image formation process exhibited excellent visualization after development (development visualization), good strength of the small dot image, and high printing durability.

### Example 2

(Preparation of Support Having a Hydrophilic Surface)

The hydrophilic layer coating liquid used in Example 1 was coated on the support as shown in Table 5 (on the roughened surface of the support 2), employing a wire bar, and dried at 120° C. for 3 minutes to obtain a hydrophilic layer with a dry coating amount as shown in Table 5. The resulting support was further subjected to aging at 60° C. for 24 hours to obtain a hydrophilic support having a hydrophilic surface.

The reflection density of the hydrophilic surface was measured in the same manner as in Example 1. The results are shown in Table 5.

(Preparation of Printing Plate Material Samples Comprising a Hydrophilic Support Having a Hydrophilic Surface and Provided Thereon, an Image Formation Layer)

Materials as shown in Table below were sufficiently mixed while stirring, and filtered to obtain an image formation layer coating liquids 4 through 7 with a solid content of 10% by weight.

TABLE 4
Composition of Image Formation Layer Coating Liquids
4 through 7 (Numerical values in Table 4 are parts
by weight, unless otherwise specified.)

| | | Image | Image | Image | Image |
|---|---|---|---|---|---|
| | | formation | formation | formation | formation |
| | | layer | layer | layer | layer |
| | | coating | coating | coating | coating |
| Materials | | liquid 4 | liquid 5 | liquid 6 | liquid 7 |
| White heat | (a′) | | 23.00 | 12.50 | 18.75 |
| melting | | | | | |
| particles | | | | | |
| Heat | (b) | 14.44 | | | |
| fusible | | | | | |
| particles | | | | | |
| Blocked | (c) | 2.27 | | 11.14 | 5.45 |
| isocyanate | | | | | |
| compound | | | | | |
| Water- | (d) | | 2.33 | | |
| soluble | (e) | 48.00 | | | |
| compound | | | | | |
| Surfactant | (f) | 10.00 | 10.00 | 10.00 | 10.00 |

| | | | | |
|---|---|---|---|---|
| Pure water | 25.29 | 64.67 | 66.36 | 65.80 |

(a′): Microcrystalline wax emulsion A206 (average particle size: 0.5 μm, softening point: 65° C., melting point: 108° C., melt viscosity at 140° C.: 8 cps, a solid content: 40% by weight, produced by GifuCerac Co., Ltd.)
(b): Acrylonitrile · styrene · alkyl acrylate · methacrylic acid copolymer emulsion Yodosol GD87B (average particle size: 90 nm, Tg: 60° C., solid content: 45% by weight, produced by Nippon NCS Co., Ltd.)
(c): Aqueous dispersion (with a solid content of 44% by weight) of blocked isocyanate compound WB-700 (produced by Mitsui Takeda Chemical Co., Ltd., isocyanate compound: trimethylolpropane adduct of TDI, blocking material: oxime type, releasing temperature: 120° C.)
(d): Sodium polyacrylate, AQUALIC DL522 (produced by Nippon Shokubai Co., Ltd., solid content: 30% by weight)
(e): Aqueous 5% by weight solution of disaccharide trehalose (Trade name: Treha, mp. 97° C, produced by Hayashihara Shoji Co., Ltd.)
(f): Surfinol 465 (produced by Air Products Co., Ltd.) 1% by weight aqueous solution

The image formation layer coating liquid was coated on the resulting hydrophilic support with constitution as shown in Table 5, employing a wire bar, dried at 55° C. for 3 minutes, and further subjected to aging at 50° C. for 48 hours to obtain a printing plate material sample. Thus, printing plate material samples 12 through 17 were obtained. The reflection density of the image formation layer surface of the resulting printing plate material samples was measured in the same manner as above. The results are shown in Table 5.

(A Step of Imagewise Exposing the Printing Plate Material Employing an Infrared Laser to Fix the Image Formation Layer at Exposed Portions onto the Hydrophilic Surface of the Hydrophilic Support, Increasing a Reflection Density of the Image Formation Layer Surface at Exposed Portions)

Each of the resulting printing plate material samples was imagewise exposed in the same manner as in Example 1. Exposure energy, which was applied to each of the printing plate material samples, is shown in Table 6.

Evaluation of Visualization

A reflection density of the image formation layer surface at exposed portions of the exposed printing plate material sample was measured in the same manner as above. Further, a reflection density of the image formation layer surface at unexposed portions was measured in the same manner as above, and the reflection density difference of the image formation layer surface between the exposed portions and unexposed portions {(reflection density of image formation layer surface at exposed portions) minus (reflection density of image formation layer surface at unexposed portions)} was determined. Furthermore, visualization was visually observed according to the same criteria as Example 1 above. The results are shown in Table 6.

Evaluation of Printability

The exposed printing plate sample being mounted on a plate cylinder of a printing press, DAIYA 1F-1 produced by Mitsubishi Jukogyo Co., Ltd., printing was carried out in the same printing condition and printing sequence as a conventional PS plate, employing coated paper, a dampening solution, a 2% by weight solution of Astromark 3 (produced by Nikken Kagaku Kenkyusyo Co., Ltd.) and printing ink (Toyo King Hyunity M Magenta, produced by Toyo Ink Manufacturing Co. Ltd.).

Evaluation of Initial Printability (Anti-Stain Property)

The number of prints printed from the beginning of printing until a print with good image was obtained was determined, and evaluated as a measure of anti-stain property. Herein, “good image” means an image with a solid image having a density of not less than 1.5 and without stain at the background. The results are shown in Table 6.

Evaluation of Small Dot Image Reproduction (Printing Durability)

Printing was carried out to obtain five thousand prints, employing the exposed printing plate material sample. Reproduction of an image with small dots in the one thousandth print and five thousandth print was observed as a measure of printing durability. An image with the smallest dots fully reproduced was observed with a loupe and the dot area (%) of the image was determined. The results are shown in Table 6.

TABLE 5

| | | | | | | Reflec- |
|---|---|---|---|---|---|---|
| | | Dry | Reflec- | | Dry | tion |
| | | coating | tion | | coating | density |
| | | amount | density | Image | amount | of image |
| Printing | | of | of | for- | of image | for- |
| plate | | hydro- | hydro- | mation | for- | mation |
| material | Sub- | philic | philic | layer | mation | layer |
| sample | strate | layer | layer | coating | layer | side |
| No. | No. | (g/m²) | surface | liquid | (g/m²) | surface |
| 12 | 2 | 5.5 | 2.05 | 4 | 0.6 | 1.90 |
| 13 | 2 | 5.5 | 2.05 | 5 | 0.7 | 1.15 |
| 14 | 2 | 5.5 | 2.05 | 5 | 1.5 | 0.85 |
| 15 | 2 | 5.5 | 2.05 | 6 | 0.7 | 1.30 |
| 16 | 2 | 5.5 | 2.05 | 7 | 0.7 | 1.20 |
| 17 | 2 | 3.0 | 1.55 | 6 | 0.3 | 1.20 |

TABLE 6

| | | | Reflection density | | | | | |
|---|---|---|---|---|---|---|---|---|
| | | Reflection | difference of | | | | | |
| Printing | | density of | image formation | | | Small dot | Small dot | |
| plate | | image formation | layer surface | | | image | image | |
| material | Exposure | layer surface | between exposed | | Initial | reproduction | reproduction | |
| sample | energy | at exposed | portions and | Visual- | printability | at 1,000^{th} | at 5,000^{th} | |
| No. | (mJ/cm²) | portions | unexposed portions | ization | (number) | print | print | Remarks |
| 12 | 400 | 1.85 | 0.05 | E | 10 | 1% | 1% | Comp. |
| 13 | 200 | 2.15 | 1.00 | A | 10 | 1% | 1% | Inv. |
| 14 | 300 | 2.15 | 1.30 | A | 15 | 1% | 1% | Inv. |
| 15 | 300 | 1.85 | 0.55 | B | 10 | 1% | 1% | Inv. |
| 16 | 300 | 2.05 | 0.85 | A | 10 | 1% | 1% | Inv. |
| 17 | 250 | 1.55 | 0.35 | B | 10 | 1% | 1% | Inv. |

Comp.: Comparative,
Inv.: Inventive

As is apparent from Tables 5 and 6, the inventive sample, comprising an image formation layer capable of being developed on a plate cylinder of a printing press, and the inventive image formation process exhibited an excellent visualization property after exposure, an excellent anti-stain property, high printing durability, and excellent printability.

1. A printing plate material comprising a hydrophilic support having a hydrophilic surface, and provided thereon, an image formation layer, wherein the hydrophilic surface of the hydrophilic support has a reflection density of not less than 1.0, and a reflection density of the image formation layer side surface of the printing plate material is not less than 0.2 lower than that of the hydrophilic surface.

2. The printing plate material of claim 1, wherein the reflection density of the image formation layer side surface is not less than 0.3 lower than that of the hydrophilic surface.

3. The printing plate material of claim 2, wherein the reflection density of the image formation layer side of the surface is not less than 0.4 lower than that of the hydrophilic surface.

4. The printing plate material of claim 1, wherein the hydrophilic surface is a hydrophilic layer surface, the hydrophilic layer containing a colorant.

5. The printing plate material of claim 4, wherein the colorant content of the hydrophilic layer is from 10 to 80% by weight.

6. The printing plate material of claim 4, wherein the colorant is black pigment selected from titanium black, a complex metal oxide pigment, a black iron oxide pigment, and carbon black pigment covered with silica materials.

7. The printing plate material of claim 1, wherein the image formation layer contains white pigment.

8. The printing plate material of claim 7, wherein the white pigment content of the image formation layer is 5 to 90% by weight.

9. The printing plate material of claim 7, wherein the white pigment is selected from titanium oxide, and hollow polymer particles.

10. The printing plate material of claim 1, wherein the image formation layer contains white heat melting particles having a melting point of from 60 to 150° C.

11. The printing plate material of claim 10, wherein the white heat melting particle content of the image formation layer is 40 to 100% by weight.

12. The printing plate material of claim 10, wherein the white heat melting particles are selected from particles of paraffin wax, polyethylene wax, carnauba wax, and microcrystalline wax.

13. The printing plate material of claim 1, wherein the image formation layer is capable of being developed with water.

14. The printing plate material of claim 1, wherein the image formation layer is capable of being developed on a printing press.

15. An image formation process employing the printing plate material of claim 1, the process comprising the steps of:
imagewise exposing the printing plate material; and
developing the exposed printing plate material to remove an image formation layer at unexposed portions.

16. An image formation process employing the printing plate material of claim 1, the process comprising the steps of:
imagewise exposing the printing plate material, so that a reflection density of the image formation layer side surface of the printing plate material is not less than 0.2 higher at exposed portions than at unexposed portions.

17. The image formation process of claim 16, wherein the imagewise exposure is carried out at exposure energy of from 50 to 1000 mJ/cm².

18. The image formation process of claim 16, wherein the image formation layer contains white heat melting particles having a melting point of from 60 to 150° C.

19. The image formation process of claim 18, wherein the white heat melting particle content of the image formation layer is 40 to 100% by weight.

20. The image formation process of claim 18, wherein the white heat melting particles are selected from particles of paraffin wax, polyethylene wax, carnauba wax, and microcrystalline wax.
